(19) United States
(12) Patent Application Publication
(10) Pub. No.: US 2024/0315234 A1
(43) Pub. Date: Sep. 26, 2024

(54) METHODS AND SYSTEMS FOR INSTALLING BIRD FLIGHT DIVERTERS

(71) Applicant: FT Holdings Inc., Calgary (CA)

(72) Inventors: Jason Peter Clarke, Calgary (CA); Daniel John Clarke, Calgary (CA)

(73) Assignee: FT Holdings Inc., Calgary, AB (CA)

(21) Appl. No.: 18/611,341

(22) Filed: Mar. 20, 2024

Related U.S. Application Data
(60) Provisional application No. 63/453,992, filed on Mar. 22, 2023.

(51) Int. Cl. A01M 29/32

(52) U.S. Cl. CPC A01M 29/32

(57) ABSTRACT

A system and method for installing bird flight diverters on wires, such as power lines and guy wires, is described. The system and method include the use of a robotic line crawler onto wires where the line crawler is configured to place bird flight diverters on the wire as the line crawler travels along the wire.

### CROSS-REFERENCE TO RELATED APPLICATIONS

This application claims priority of U.S. provisional patent application Ser. No. 63/453,992 filed Mar. 22, 2023, which is incorporated by reference into this application in its entirety.

### TECHNICAL FIELD

The present disclosure is related to the field of methods and systems for installing bird flight diverters on wires including, but not limited to, power lines and guy wires, in particular, systems and methods comprising a remotely controllable line crawlers configured to place bird flight diverters along the wire as the line crawler travels along the wire.

### BACKGROUND

Physical contact between birds and power lines is a problem. When a bird makes contact with a live power line, it creates a hazard for both the power grid and for the bird. Bird flight diverters are devices placed on power lines, guy wires and shield wires to provide a means to visibly alert birds to the wires with the intent to divert the bird's flight from the wires.

Referring to FIGS. 1 to 5, a prior art bird flight diverter 1 is shown, as manufactured by Preformed Line Products Company of Cleveland, Ohio, USA. The purpose of this device is to be affixed to a power line shield or conductor wire to make the wires visible to wildlife such as birds. This reduces the incidence of wildlife striking the power line which can cause either injury or death to the animal as well as damage to the electrical power transmission infrastructure. These devices are installed at regular intervals along the wire at a spacing that is optimised to provide maximum visibility to wildlife while still being cost effective.

In some embodiments, prior art diverter 1 can be comprised of a single conical helix manufactured from gray or yellow high impact PVC. The prior art diverter can comprise a helix configuration designed to wrap around the outer diameter of conductor wire 2, wherein diverter 1 is retained on wire 2 via the positive grip of the helix on wire 2. There are a number of diverters 1 sizes available to accommodate various diameters of wire 2.

FIGS. 1 and 2 show a side view and an isometric view, respectively, of prior art bird flight diverter 1 prior to installation. FIGS. 3 and 4 show a side view and front view, respectively, of the beginning of the installation process to install diverter 1 onto wire 2. The conical helix of diverter 1 assists in guiding diverter 1 onto wire 2 through a rotation 18 about the axis of the helix. FIG. 5 shows an isometric view of multiple diverters 1 installed onto wire 2 at a predetermined distance to maximize visibility while minimizing cost. One end of the conical helix of diverter 1 has a diameter small enough to allow the diverter to positively grip wire 2 when completely wrapped therearound. This positive grip retains diverter 1 in place on wire 2.

Prior art methods of installing bird flight diverters 1 on wire 2 include a person trained in the art installing diverters 1 by hand while riding in a helicopter which hovers beside wire 2. The diverter 1 is rotated by hand, wrapping the helix portion around wire 2, which is a physically difficult and repetitive task to complete. This method of installation is expensive, physically demanding, and extremely dangerous, which creates a need for a safer and cheaper method.

It is, therefore, desirable to provide a system and method of installing bird flight diverters on wires that is both safer and cheaper.

### SUMMARY

A method and system for installing conical helix bird flight diverters onto a suspended wire is provided. The system can comprise a robotic line crawler that can be configured to move along the longitudinal length the wire and install a plurality of the bird flight diverters thereon.

Broadly stated, in some embodiments, a method can be provided for installing a plurality of bird flight diverters onto a longitudinal length of a wire, wherein each bird flight diverter comprises a conical helix configured to wrap around the wire, the method comprising: placing a robotic line crawler on the wire, the robotic line crawler configured to hold a plurality of the bird flight diverters, the robotic line crawler further configured to traverse along the longitudinal length of the wire; moving the robotic line crawler along the longitudinal length of the wire; and installing the conical helix of one or more of the plurality of the bird flight diverters on the wire.

Broadly stated, in some embodiments, wherein installing the conical helix can comprise rotating the conical helix onto the wire.

Broadly stated, in some embodiments, the method can further comprise installing two or more of the plurality of the bird flight diverters at pre-determined spaced-apart intervals along the wire.

Broadly stated, in some embodiments, a system can be provided for installing a plurality of bird flight diverters onto a longitudinal length of a wire, wherein each bird flight diverter comprises a conical helix configured to wrap around the wire, the system comprising: a longitudinal backbone member having first and second ends; a drive wheel disposed on the first end and an idler wheel disposed on the second end, the drive wheel configured for moving the system along the wire; a plurality of balancing struts extending downwardly from the backbone member; and at least one carrier assembly disposed on the backbone member, wherein the at least one carrier assembly comprises one or more grips wherein each grip is configured for holding one of plurality of bird diverters, wherein the at least one carrier assembly comprises a first rotating assembly for rotating the grips whereby rotation of the grips results in the conical helix of one of the plurality of bird diverters disposed in one of the grips is being rotated onto the wire.

Broadly stated, in some embodiments, the drive wheel can comprise an electric motor disposed therein for rotating the drive wheel.

Broadly stated, in some embodiments, the system can further comprise a lifting mechanism for raising and lowering the system relative to the wire.

Broadly stated, in some embodiments, the lifting mechanism can comprise a servo motor, a pivot arm and linkage operatively disposed between the backbone member and one or both of the drive wheel and the idler wheel.

Broadly stated, in some embodiments, the system can further comprise one or more horizontal rails disposed between pairs of the plurality of balancing struts.

Broadly stated, in some embodiments, the system can further comprise at least one battery disposed on the one or more horizontal rails for providing electric power to the drive wheel and to the at least one carrier assembly.

Broadly stated, in some embodiments, the at least one carrier assembly can comprise a second rotating assembly for rotating the at least one carrier assembly relative to the backbone member whereby the at least one carrier assembly rotates to position one of the plurality of bird flight diverters into a location for installation onto the wire prior to the first rotating assembly rotating the one of the plurality of bird flight diverters onto the wire.

### BRIEF DESCRIPTION OF THE DRAWINGS

FIG. 1 is a side elevation view depicting a prior art bird flight diverter.

FIG. 2 is an isometric view depicting the prior art bird flight diverter of FIG. 1.

FIG. 3 is a side elevation view depicting the prior art bird flight diverter of FIG. 1 at the beginning of being installed on a wire.

FIG. 4 is an end elevation view depicting the prior art bird flight diverter of FIG. 3.

FIG. 5 is an isometric view depicting a plurality of the prior art bird diverters of FIG. 1 on a wire.

FIG. 6 is an isometric view depicting one embodiment of a robotic system for installing bird flight diverters.

FIG. 7 is an isometric view depicting the robotic system of FIG. 6 on a wire having installed prior art bird diverters.

FIG. 8 is an isometric view depicting one embodiment of a bird diverter carrier assembly of the robotic system of FIG. 6.

FIG. 9 is a sectioned isometric view depicting a rotary mechanism of the bird diverter carrier assembly of FIG. 8.

FIG. 10 is a sectioned isometric view depicting one embodiment of a bird diverter grip for use on the bird diverter carrier assembly of FIG. 8.

FIG. 11 is an isometric view depicting the bird diverter carrier assembly of FIG. 8 at the start of a process to install a prior art bird flight diverter on the wire.

FIG. 12 is an isometric view depicting the bird diverter carrier assembly of FIG. 11 after a prior art bird flight diverter has been installed on the wire.

FIG. 13 is a side elevation view depicting the robotic system of FIG. 6.

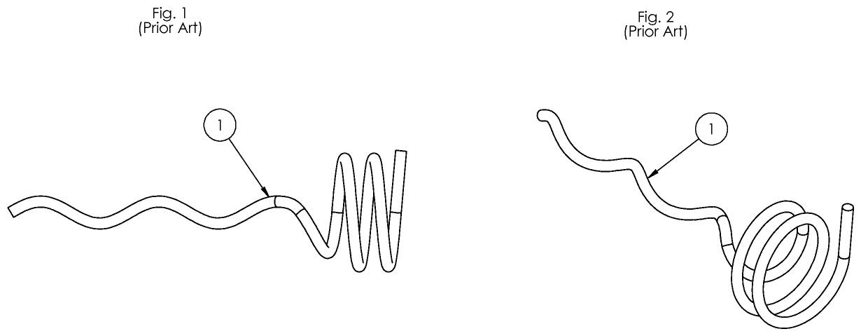

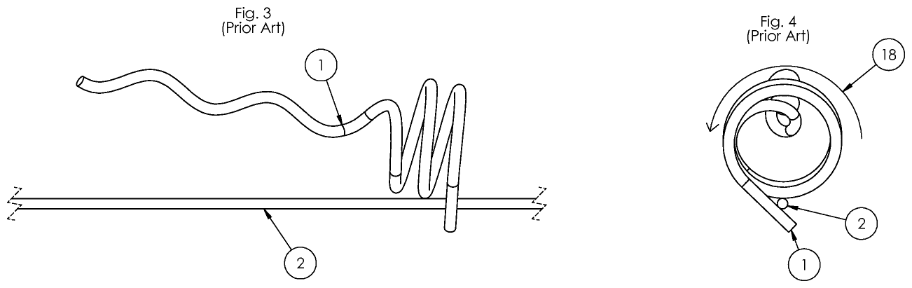

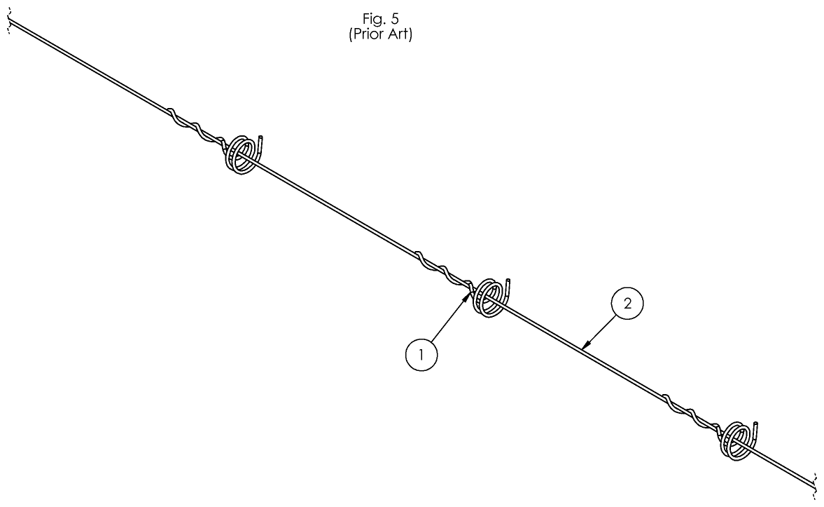

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments but is not necessarily included. Thus, the present technology can include a variety of combinations and/or integrations of the embodiments described herein.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

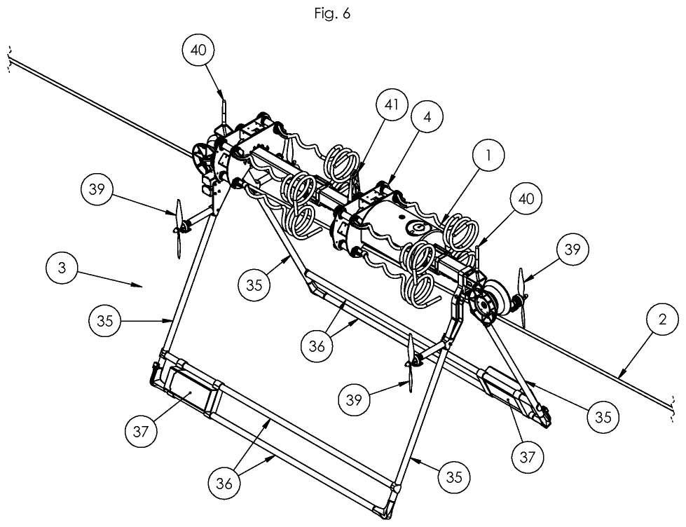

Referring to FIG. 6, an isometric view of one embodiment of bird flight diverter installing robot 3 (hereinafter referred to as “robot 3”) is shown disposed on wire 2 prior to installing one or more bird flight diverters 1 onto wire 2. In some embodiments, robot 3 can comprise one or more bird flight diverter carrier assemblies 4 (hereinafter referred to as “carrier assembly 4”) disposed thereon. In some embodiments, each carrier assembly 4 can be configured is designed to hold and mount one or more diverters 1 for installation onto wire 2. In the illustrated embodiment, carrier assembly 4 is configured to hold and mount up to 4 diverters 1. In some embodiments, a plurality of carrier assemblies 4 can be installed on robot 3 to minimize set-up and installation time for installing multiple diverters 1 onto wire 2.

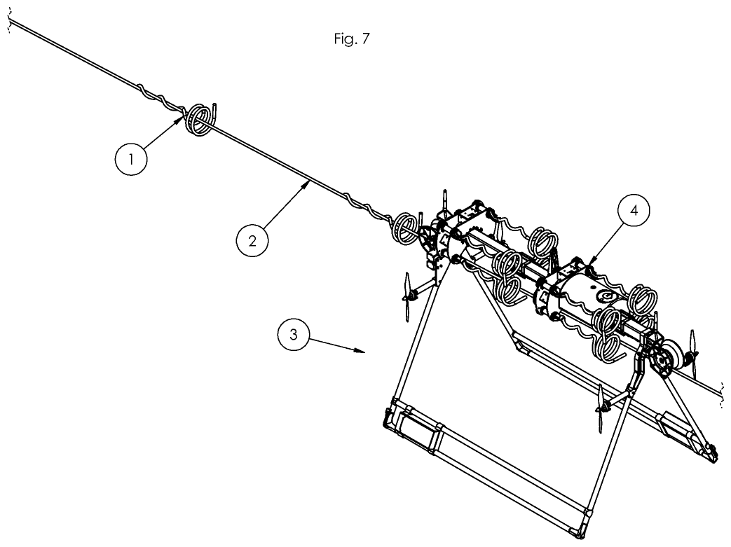

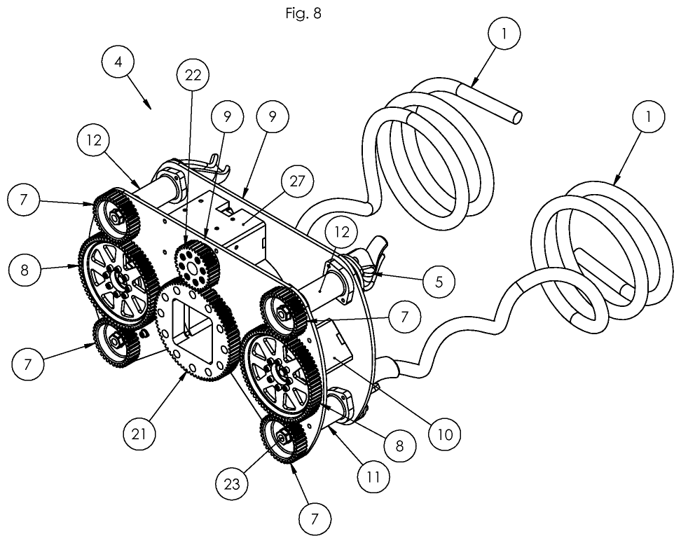

Referring to FIG. 7, an isometric view is shown of robot 3 running along wire 2 after multiple diverters 1 have been installed onto wire 2. Installation spacing of diverters 1 can be preprogrammed in robot 3 or manually controlled by an operator on the ground.

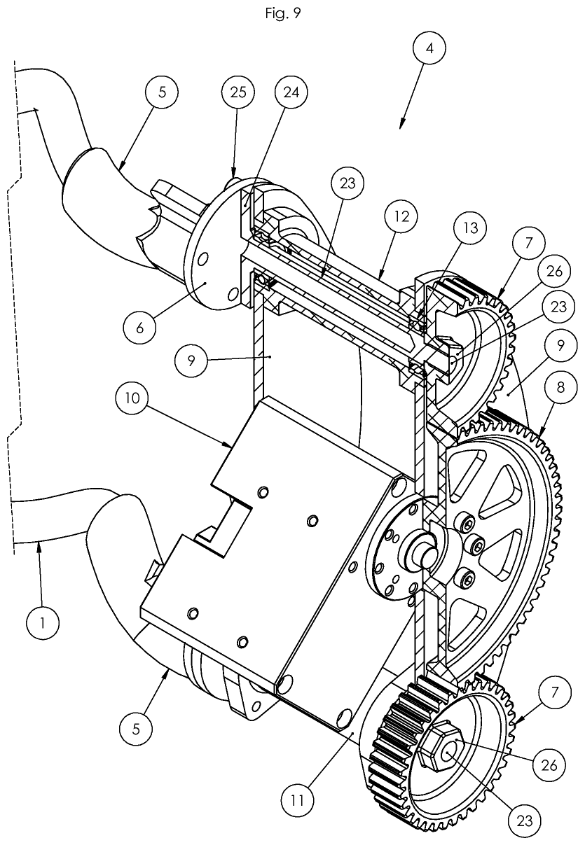

Referring to FIG. 8, an isometric view is shown of one embodiment of carrier assembly 4. In some embodiments, carrier assembly 4 can comprise of a plurality of bird flight diverter grips 5, wherein each grip 5 is operatively coupled to one of a plurality of driven gears 7. In some embodiments, carrier assembly 4 can further comprise a plurality of drive gears 8 operatively coupled to driven gears 7, a plurality of bird flight diverter arms 9, a plurality of servo motors 10, a plurality of lower bearing housings 11, a plurality of upper bearing housings 12, assembly driven gear 21, and assembly drive gear 22 operatively coupled to servo motor 27. In some embodiments, servo motor 27, drive gear 22 and drive gear 21 can form a second rotating assembly for rotating carrier assembly 4 relative to backbone member 38 as shown in FIG. 13. In some embodiments, bird flight diverter arm 9 can make up the structural frame of carrier assembly 4 along with lower bearing housing 11 and upper bearing housing 12, while further providing the connection of carrier assembly 4 to robot 3. In some embodiments, each of the plurality of grips 5 are fastened one of a plurality of grip bolts 23 via grip flange 6 fastened to grip bolt flange 24 with fasteners 25. In some embodiments, each of the plurality of grip bolts 23 can be rotatably disposed within one of the plurality of lower bearing housings 11 and the plurality of upper bearing housings 12. In some embodiments, a threaded end of each of the plurality of grip bolts 23 can be threadably fastened to a grip bolt nut 26 disposed in each of the plurality of driven gears 7, as shown in greater detail in FIG. 9. A plurality of servo motors 10 can be bolted between a pair of the plurality of diverter arms 9, wherein a first rotating assembly can be formed comprising one of the plurality of servo motors 10 coupled to one of the plurality of drive gears 8 that can, in turn, drive the plurality of driven gears 7 whereby grips 5 can be rotated by servo motors 10 to install one of the bird flight diverters 1 onto wire 2.

Referring to FIG. 9, a sectioned isometric view of carrier assembly [4] rotary mechanism is shown. In addition to the previously mentioned assembly components, carrier assembly 4 can also comprise of a plurality of ball bearings 13 disposed within each of the plurality of upper bearing housings 12 and the plurality of lower bearing housings 11. Bearings 13 can rotatably support grip bolt 23 disposed therein.

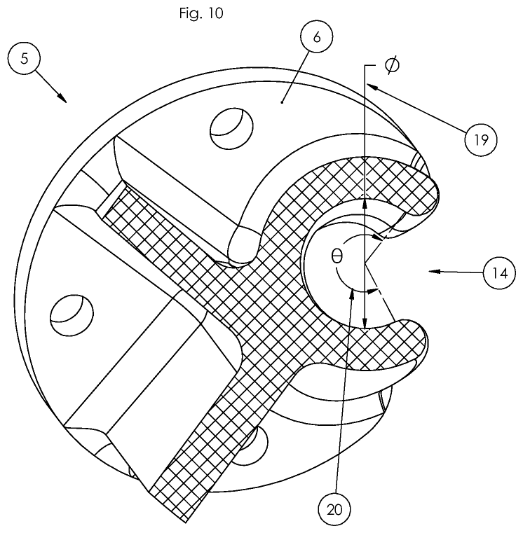

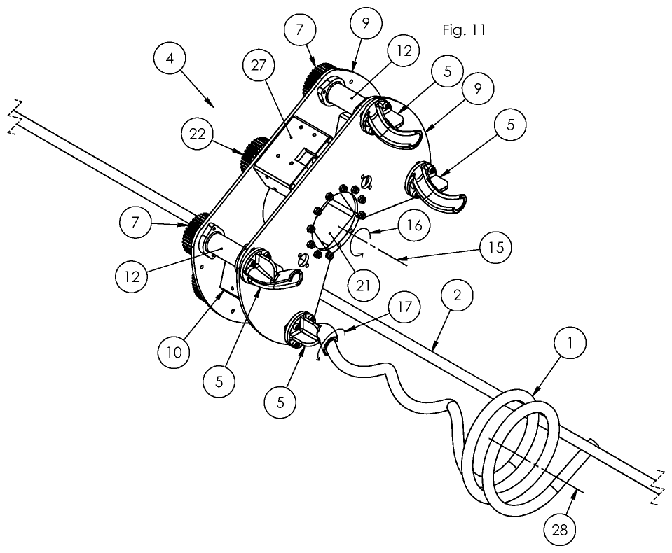

Referring to FIG. 10, a sectioned view of grip 5 is shown, sectioned perpendicular to helical groove 14. In some embodiments, grip 5 can be configured to retain a specific sized diverter 1 by utilizing a major arc groove extruded with a helical pitch to match that of diverter 1. In some embodiments, internal diameter 19 of the major arc can be undersized compared to diverter 1 wire outer diameter. Diverter 1 can be installed into grip 5 by sliding diverter 1 down helical groove of grip 5 until the end of diverter 1 bottoms out at base flange 6 of grip 5. The major arc can comprise a central angle 20 greater than 180 degrees, allowing it to retain the diameter of diverter 1 when assembled. Diverter 1 can be released from grip 5 during the installation process, by applying a pull force on diverter 1 perpendicular to the helical centerline and directed away from the major arc, towards the open side of helical groove 14. In some embodiments, grips 5 can be made of material with a relatively low Young's Modulus, giving grips 5 sufficient elasticity for releasing diverters 1 out of grip 5 during the installation process.

Referring to FIG. 11, an isometric view is shown of carrier assembly 4 installing a bird flight diverter 1 onto wire 2. In some embodiments, carrier assembly 4 can operatively coupled to robot 3 whereby rotation of drive gear 22 by servo motor 27 can cause carrier assembly 4 to rotate about axis 15 in rotation direction 16. The rotation of carrier assembly 4 about axis 15 can be used to control the distance of diverter 1 relative to wire 2 during the installation process. During installation it is necessary to rotate diverter 1 about the helical axis 28 in rotation direction 17, which can be achieved by rotating grip 5 with servo motor 10 through the gear train of gears 7 and 8. Due to the conical nature of diverter 1, carrier assembly 4 can rotate as necessary to bring grip 5 closer in relation to wire 2 as diverter 1 is rotated about rotation direction 17.

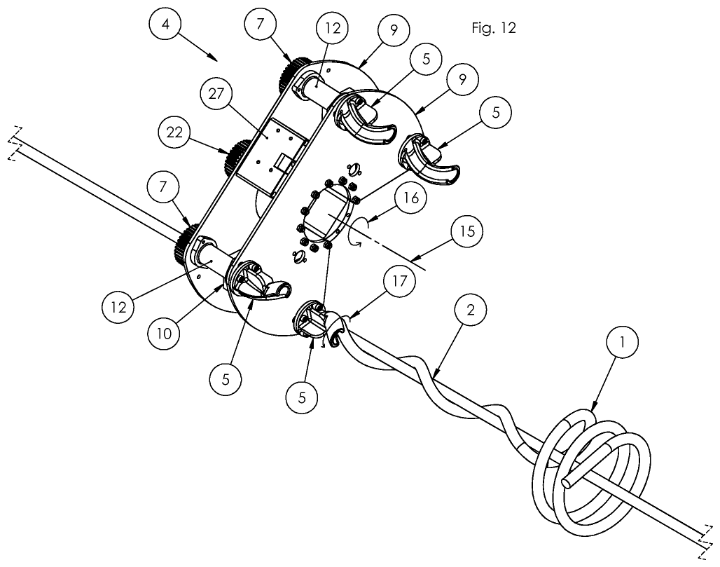

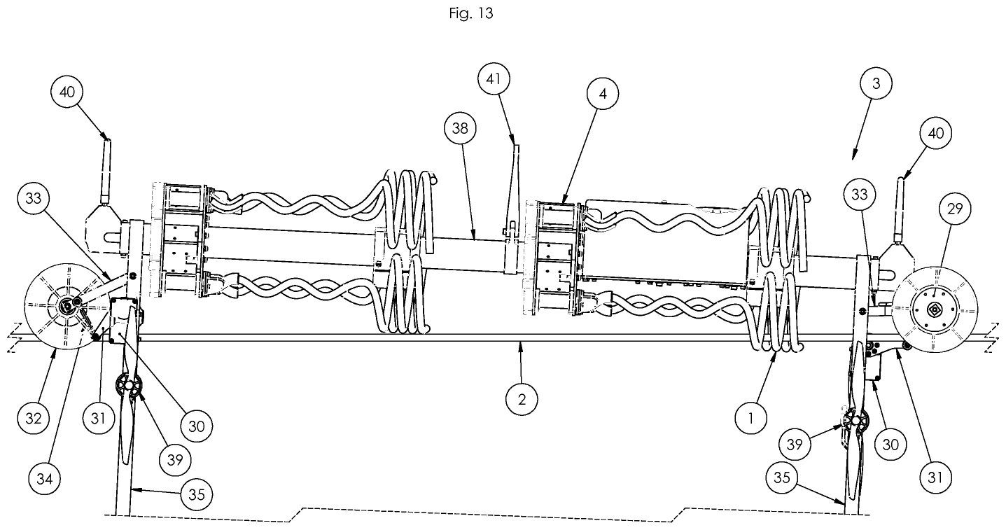

Referring to FIG. 12, an isometric view is shown of carrier assembly 4 immediately after a bird flight diverter 1 has been installed onto wire 2. At this point in the process, grip 5 can be at its closest proximity to wire 2. When diverter 1 is installed on wire 2 up to grip 5, the positive grip strength of diverter 1 on wire 2 is enough to overcome the retaining force of grip 5, thereby pulling the end of diverter 1 out of grip 5 for it to finish wrapping around wire 2. The rotation orientation of 16 and 17 can be predetermined and controlled by robot 3 specific to the diverter 1 and wire 2 used in the application.

Referring to FIG. 13, a side elevation view is shown of one embodiment of robot 3 before the installation of a bird flight diverter 1. In the illustrated embodiments, robot 3 can comprise of a plurality of carrier assemblies 4, drive wheel 29, a plurality of electric servo motors 30, a plurality of rotating servo horns 31, idler wheel 32, a plurality of pivot arms 33 and linkage 34. In the illustrated embodiment, idler wheel 32 is shown with its linkage 34 visible. Drive wheel 29 similarly comprises linkage 34 disposed between its servo motor 30 and pivot arm 33 but linkage 34 is disposed on an opposing side of drive wheel 29 and, thus, not visible in FIG. 13. In some embodiments, robot 3 can rest on wire 2 via drive wheel 29 and idler wheel 32. In some embodiments, robot 3 can comprise of longitudinal backbone member 38 having a plurality of balancing struts 35 extending downwardly therefrom. Referring to FIG. 6, robot 3 can further comprise rails 36 disposed between pairs of balancing struts 35 to provide rigidity and stability for the structure of robot 3. In some embodiments, robot 3 can comprise batteries 37 disposed on rails 36 on opposing sides of robot 3 that can provide electric power for electronics and electric servo motors disposed thereon, and to provide mass as ballast to robot 3 that can provide stability thereto when robot 3 is placed on wire 2. In some embodiments, robot 3 can comprise a plurality of lateral thrusters 39, which can comprise of a propeller coupled to an electric motor, to provide lateral thrust and stability to keep robot 3 in an upright position as it moves along wire 2. In some embodiments, robot 3 can comprise of lifting member 41 configured for receiving a hook or other means for lifting robot 3 on and off of wire 2.

Referring to FIG. 13, in some embodiments, drive wheel 29 and idler wheel 32 can be mounted to robot 3 through pivot arms 33. In some embodiments, servo motors 30 can be actuated to pivot one or both of drive wheel 29 and idler wheel 32 through the connection of servo horns 31 and linkage 34. This pivot actuation can provide a degree of freedom, allowing robot 3 to incline relative to wire 2 to give clearance of wire 2 to slide in between the helix of diverter 1 during the installation process. In some embodiments, drive wheel 29 can comprise an electric motor disposed therein to allow robot 3 to traverse along wire 2 so that robot 3 can place diverters 1 at designated locations along wire 2. In some embodiments, drive wheel 29 and servo motors 30 can be operated by a microprocessor, a microcontroller or other electronic logic control mechanism, as well known to those skilled in the art, disposed in or on robot 3 (not shown). In other embodiments, drive wheel 29 and servo motors 30 can be manually controlled remotely by an operator located on the ground using a remote control wireless transmitter (not shown) configured to communicate with a wireless receiver disposed on robot 3 (not shown) via antennas 40, the wireless receiver operatively coupled to drive wheel 29 and servo motors 30 and configured to relay control signals to drive wheel 29 and servo motors 30 derived from commands wirelessly received from the wireless transmitter.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A method for installing a plurality of bird flight diverters onto a longitudinal length of a wire, wherein each bird flight diverter comprises a conical helix configured to wrap around the wire, the method comprising:
a) placing a robotic line crawler on the wire, the robotic line crawler configured to hold a plurality of the bird flight diverters, the robotic line crawler further configured to traverse along the longitudinal length of the wire;
b) moving the robotic line crawler along the longitudinal length of the wire; and
c) installing the conical helix of one or more of the plurality of the bird flight diverters on the wire.

2. The method as set forth in claim 1, wherein installing the conical helix comprises rotating the conical helix onto the wire.

3. The method as set forth in claim 1, further comprising installing two or more of the plurality of the bird flight diverters at pre-determined spaced-apart intervals along the wire.

4. The method as set forth in claim 1, wherein the robotic line crawler comprises:
a) a longitudinal backbone member having first and second ends;
b) a drive wheel disposed on the first end and an idler wheel disposed on the second end, the drive wheel configured for moving the system along the wire;
c) a plurality of balancing struts extending downwardly from the backbone member; and
d) at least one carrier assembly disposed on the backbone member, wherein the at least one carrier assembly comprises one or more grips wherein each grip is configured for holding one of plurality of bird diverters, wherein the at least one carrier assembly comprises a first rotating assembly for rotating the grips whereby rotation of the grips results in the conical helix of one of the plurality of bird diverters disposed in one of the grips is being rotated onto the wire.

5. The method as set forth in claim 4, wherein the drive wheel comprises an electric motor disposed therein for rotating the drive wheel.

6. The method as set forth in claim 4, wherein the robotic line crawler further comprises a lifting mechanism for raising and lowering the system relative to the wire.

7. The method as set forth in claim 6, wherein the lifting mechanism comprises a servo motor, a pivot arm and linkage operatively disposed between the backbone member and one or both of the drive wheel and the idler wheel.

8. The method as set forth in claim 4, wherein the robotic line crawler further comprises one or more horizontal rails disposed between pairs of the plurality of balancing struts.

9. The method as set forth in claim 8, wherein the robotic line crawler further comprises at least one battery disposed on the one or more horizontal rails for providing electric power to the drive wheel and to the at least one carrier assembly.

10. The method as set forth in claim 4, wherein the at least one carrier assembly comprises a second rotating assembly for rotating the at least one carrier assembly relative to the backbone member whereby the at least one carrier assembly rotates to position one of the plurality of bird flight diverters into a location for installation onto the wire prior to the first rotating assembly rotating the one of the plurality of bird flight diverters onto the wire.

11. A system for installing a plurality of bird flight diverters onto a longitudinal length of a wire, wherein each bird flight diverter comprises a conical helix configured to wrap around the wire, the system comprising:
a) a longitudinal backbone member having first and second ends;
b) a drive wheel disposed on the first end and an idler wheel disposed on the second end, the drive wheel configured for moving the system along the wire;
c) a plurality of balancing struts extending downwardly from the backbone member; and
d) at least one carrier assembly disposed on the backbone member, wherein the at least one carrier assembly comprises one or more grips wherein each grip is configured for holding one of plurality of bird diverters, wherein the at least one carrier assembly comprises a first rotating assembly for rotating the grips whereby rotation of the grips results in the conical helix of one of the plurality of bird diverters disposed in one of the grips is being rotated onto the wire.

12. The system as set forth in claim 11, wherein the drive wheel comprises an electric motor disposed therein for rotating the drive wheel.

13. The system as set forth in claim 11, further comprising a lifting mechanism for raising and lowering the system relative to the wire.

14. The system as set forth in claim 13, wherein the lifting mechanism comprises a servo motor, a pivot arm and linkage operatively disposed between the backbone member and one or both of the drive wheel and the idler wheel.

15. The system as set forth in claim 11, further comprising one or more horizontal rails disposed between pairs of the plurality of balancing struts.

16. The system as set forth in claim 15, further comprising at least one battery disposed on the one or more horizontal rails for providing electric power to the drive wheel and to the at least one carrier assembly.

17. The system as set forth in claim 11, wherein the at least one carrier assembly comprises a second rotating assembly for rotating the at least one carrier assembly relative to the backbone member whereby the at least one carrier assembly rotates to position one of the plurality of bird flight diverters into a location for installation onto the wire prior to the first rotating assembly rotating the one of the plurality of bird flight diverters onto the wire.
